(19) United States
(12) Patent Application Publication
(10) Pub. No.: US 2009/0293134 A1
(43) Pub. Date: Nov. 26, 2009

(54) IMAGE PROCESSING APPARATUS, IMAGE PROCESSING METHOD, AND PROGRAM

(75) Inventor: Hiroshi Oomura, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/431,249

(22) Filed: Apr. 28, 2009

(30) Foreign Application Priority Data
May 20, 2008 (JP) 2008-132332

(51) Int. Cl. H04L 9/32

(52) U.S. Cl. 726/28

(57) ABSTRACT

Strict security is ensured with respect to information in originals scanned by an MFP. There are provided: password detector for judging if original information obtained by decoding the two-dimensional code of original images contains a one-way hash value generated from a password; password input for prompting input of a password in the case where it is determined by the password detector that a hash value is contained in the original information; password verifier for using the one-way hash value to verify a password input by the password input; and converter for converting the original images into an electronic file protected by the password input by the password input.

### BACKGROUND OF THE INVENTION

1. Field of the Invention

The present invention relates to an image processing apparatus, an image processing method, a program, and a storage medium whereby originals containing authentication information are processed.

2. Description of the Related Art

Japanese Patent Laid-Open No. 2003-280469 discloses technology that uses two-dimensional codes to limit output of original images. More specifically, with this technology, two-dimensional codes containing authentication information (such as a code number or password) are attached to originals. Subsequently, once the originals have been scanned, it is checked whether the authentication information contained in a two-dimensional code matches authentication information input by a user via an operation unit. If the two sets of information do match, then outputting (e.g., copying) the images obtained by scanning the originals (i.e., the original images) is permitted.

In other words, with the technology disclosed in Japanese Patent Laid-Open No. 2003-280469, if authentication information contained in a two-dimensional code matches authentication information input by a user via an operation unit, then the original images are output.

However, in the technology disclosed in the above literature, if the authentication information contained in the two-dimensional code matches the authentication information input by a user via an operation unit, then the original images are output without attaching new authentication information. For this reason, if the original images are output to a PC or similar device able to view the original images, for example, then the user of that device is able to freely view the original images, and in addition, is able to create copies of the original images. Furthermore, since the password is directly embedded within the two-dimensional code, there is a possibility that the two-dimensional code will be analyzed and the embedded password will be extracted by a third party.

### SUMMARY OF THE INVENTION

The present invention, being devised in order to solve the foregoing problems, has as an object not merely to output images when outputting original images with attached two-dimensional codes, but rather to output original images after applying certain limitations thereto. Moreover, the present invention has as an object to ensure stricter security with respect to information in scanned originals.

In order to solve the above problems, an image processing apparatus of the present invention includes: password detecting means for judging if original information obtained by decoding a two-dimensional code in original images contains a one-way hash value generated from a password; password inputting means for prompting input of a password in the case where it is determined by the password detecting means that a hash value is contained in the original information; password verifying means for using the one-way hash value to verify the password input by the password inputting means; and converting means for converting the original images into an electronic file protected by the password input by the password inputting means.

In addition, a method of the present invention is an image processing method executed by an image processing apparatus, and includes: a password detecting step for determining if original information obtained by decoding a two-dimensional code in original images contains a one-way hash value generated from a password; a password inputting step for prompting input of a password in the case where it is determined in the password detecting step that a hash value is contained in the original information; a password verifying step for using the one-way hash value to verify the password input in the password inputting step; and a converting step for converting the original images into an electronic file protected by the password input in the password inputting step.

According to the present invention, certain limitations can be applied when outputting original images with an attached two-dimensional code. In addition, in the present invention, the password itself is not embedded as the authentication information, but instead, a hash value of the password is used. Consequently, stricter security can be ensured with respect to information in originals scanned by an image processing apparatus such as an MFP, without the password being discovered by a third party.

Further features of the present invention will become apparent from the following description of exemplary embodiments (with reference to the attached drawings).

### BRIEF DESCRIPTION OF THE DRAWINGS

FIG. 1 illustrates a system configuration in a first embodiment of the present invention;

FIG. 2 illustrates an example of an original group to be scanned;

FIG. 3 illustrates an example of the two-dimensional code and the original information embedded therein for original images in the first embodiment;

FIG. 4 illustrates an example of converting original images obtained by scanning into an electronic file on a per-document basis in the first embodiment;

FIG. 5 illustrates an example of collecting and converting original images obtained by scanning into a single electronic file in the first embodiment;

FIG. 6 is a flowchart of a scanning process in the first embodiment;

FIG. 7 illustrates an example of original image management data in the first embodiment;

FIG. 8 is a flowchart of electronic file conversion of original images in the first embodiment;

FIG. 9 illustrates an example of an operation screen allowing a user to select a multiple-document electronic file conversion method in the first embodiment;

FIG. 10 is a flowchart of electronic file conversion on a per-document basis in the first embodiment;

FIG. 11 illustrates an example of a scan-allow password input operation screen in the first embodiment;

FIG. 12 illustrates an example of an operation screen at the time of determining a password to be applied to an electronic file;

FIG. 13 illustrates an example of an operation screen in the case where a new password is set for an electronic file;

FIG. 14 is a flowchart of processing for combining multiple documents into a single electronic file;

FIG. 15 illustrates an example of a scan-allow password input operation screen in the first embodiment;

FIG. 16 illustrates an example of a scan-allow password input operation screen in the second embodiment;

FIG. 17 illustrates an example of a scan-allow password input operation screen in the third embodiment;

FIG. 18 illustrates an example of scan-allow password input operation screens (wizard format) in the fourth embodiment; and

FIG. 19 illustrates an example of an operation screen in the case where a password is set for an electronic file in the fourth embodiment.

### DESCRIPTION OF THE EMBODIMENTS

Hereinafter, preferred embodiments for carrying out the present invention will be described using the attached drawings.

### Embodiment 1

### (System Configuration)

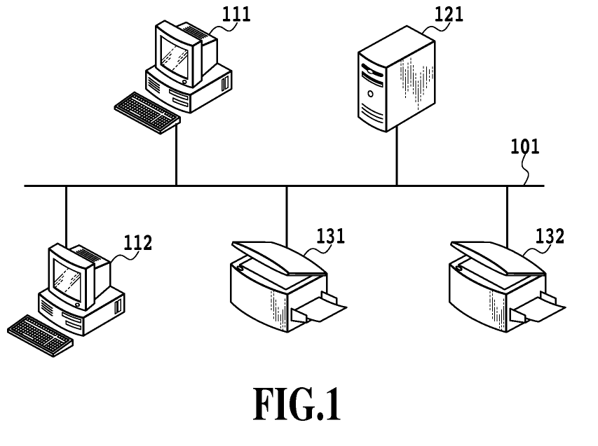

First, the general configuration of a system including an MFP in accordance with an embodiment of the present invention will be described using FIG. 1.

FIG. 1 is a diagram of the configuration of a system in the present embodiment.

The system shown by way of example in FIG. 1 includes at least an MFP 131 and a client computer 111.

The MFP 131 is able to scan, print, copy, and transmit. Other functions of the MFP 131 will become clear in the following description of the present embodiment.

Via a network 101, the client computer 111 is able to receive and save data transmitted by the MFP 131. In addition, the client computer 111 is able to display saved data.

In addition, as shown in FIG. 1, a plurality of client computers 111 and 112, a plurality of MFPs 131 and 132, and a file server 121 may also be connected to the network 101.

### (Documents and Originals)

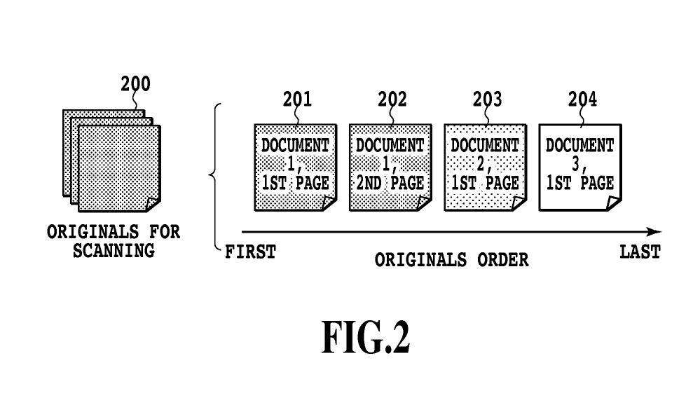

Next, the documents and originals described in the present specification will be described using FIG. 2.

FIG. 2 illustrates an example of an original group scanned by the MFP 131.

The original group scanned by the MFP 131 is not limited to being made up of a single document. In the example shown in FIG. 2, the original group is made up of a two-page document 1 (original 201, original 202), a one-page document 2 (original 203), and a similar one-page document 3 (original 204). In this way, the scanned original group is made up of a plurality of documents (obviously, the scanned original group may also be made up of a single document), with each document being made up of one or a plurality of originals.

In addition, it is also conceivable for the original group scanned by the MFP 131 to contain both documents that include a two-dimensional code, as well as documents that do not include a two-dimensional code. In the example shown in FIG. 2, the document 1 (original 201, original 202) and the document 2 (original 203) have attached two-dimensional codes in halftone dots in addition to the document content. However, a two-dimensional code is not attached to the original 204.

### (Two-Dimensional Code Information)

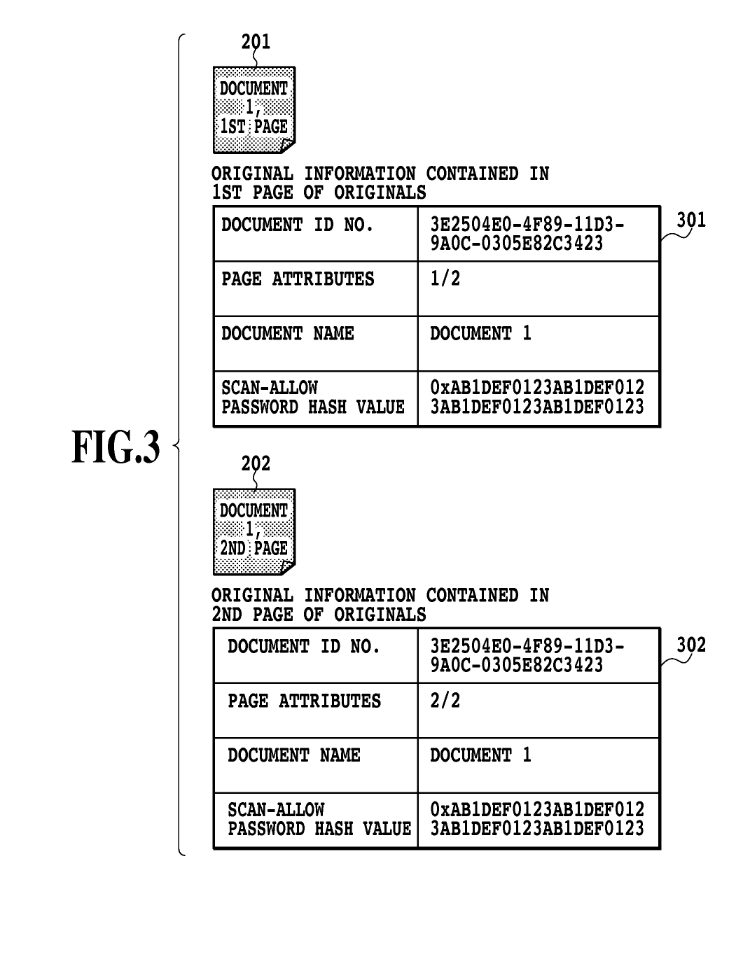

The information stored in a two-dimensional code will now be described with the additional use of FIG. 3.

The original 201 (i.e., the first page of the document 1 in FIG. 2) includes information (i.e., original information 301) stored in a two-dimensional code format. The original 202 (i.e., the second page of the document 1 in FIG. 2) includes information (i.e., original information 302) stored in a two-dimensional code format.

Herein, a two-dimensional code can store a document identification number, page attributes, a document name, and a scan-allow password hash value.

The document identification number is a number that uniquely identifies a document. In the present embodiment, a UUID (Universally Unique Identifier) is used. If the same UUID number exists in the original information for two originals, then the originals are recognized as being from the same document. In the case of different documents, different document identification numbers are stored in the original information.

Page attributes are information indicating the total number of pages in a document, and the particular page of a document to which the original corresponds. The document name is a name for uniquely identifying a document.

The scan-allow password hash value is a hash value of a password required for scan permission. In the present embodiment, SHA1 is used as the hash technique, but other hash techniques may also be used as long as password confidentiality is protected. Since the original information 301 and the original information 302 are for the same document, all information other than the page attributes (i.e., the document identification number, the document name, and the scan-allow password hash value) is the same. Herein, in the present specification, “obtaining original information from the two-dimensional code” on an original image is referred to as “decoding”.

### (Generation of an Electronic File)

When scanning an original group containing the plurality of documents in FIG. 2 that include originals with attached two-dimensional codes, there are two modes for the output mode of the electronic file that is the output result after scanning.

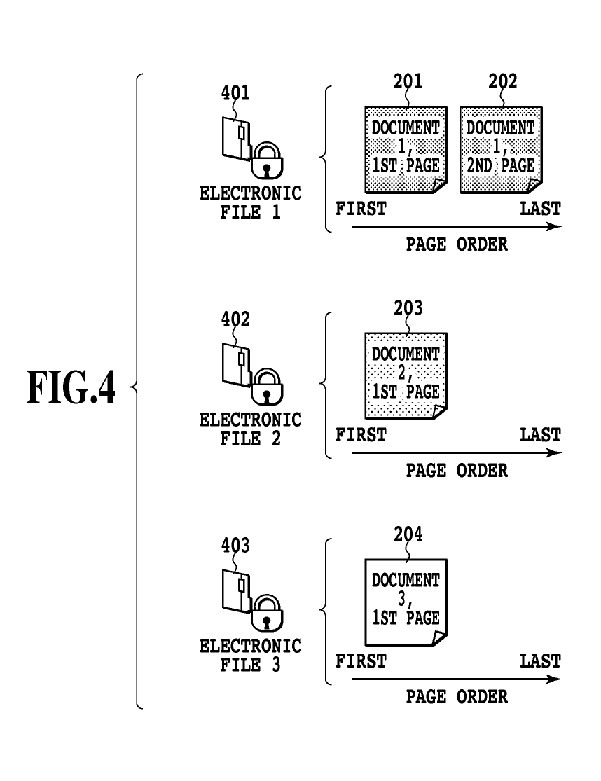

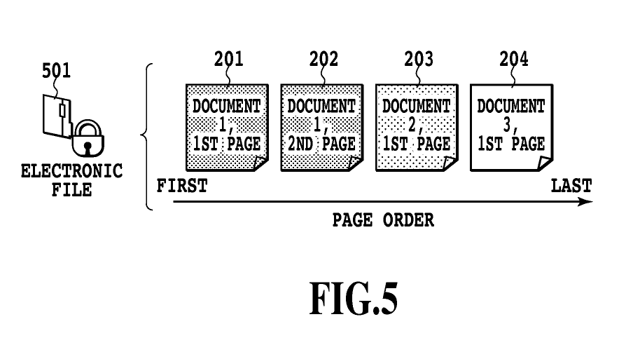

As shown in FIG. 4, one of the modes involves following the original information included in the two-dimensional codes to generate an electronic file for each document with respect to the original images obtained by scanning. The other mode involves combining all original images obtained by scanning into a single electronic file 501 like that shown in FIG. 5.

### (Mode for Generating Electronic Files on a Per-Document Basis)

The mode wherein the original information included in two-dimensional codes is followed to generate an electronic file for each document with respect to the original images obtained by scanning will now be described using FIG. 4.

FIG. 4 illustrates an example of converting original images obtained by scanning into an electronic file on a per-document basis in the first embodiment.

By decoding the two-dimensional codes on original images, images recognized as being from the same document are combined into a single electronic file. If there is no two-dimensional code on an original image, or if an original image has a two-dimensional code that cannot be recognized, then that original image is recognized and processed as a document that does not have original information. In the case where there is included a plurality of pages of such original images that do not have two-dimensional codes, those original images may be combined and output as a single electronic file.

In the example shown in FIG. 4, the original images of the original 201 (i.e., the first page of the document 1) and the original 202 (i.e., the second page of the same document 1) are combined and output as a single electronic file 401. Furthermore, by decoding the two-dimensional code on the original image, the original 203 (i.e., the first page of the document 2) is output as an electronic file 402.

In contrast, the original information is not known for the original 204 that does not have a two-dimensional code on the original image. For this reason, the original 204 is output as an electronic file 403 separate from the electronic files 401 and 402. Herein, when a scan-allow password hash value is included in the original information for each document shown in FIG. 4, it is necessary to conduct a permission check using the password for each document when the MFP 131 scans.

(Mode for Combining into a Single Electronic File)

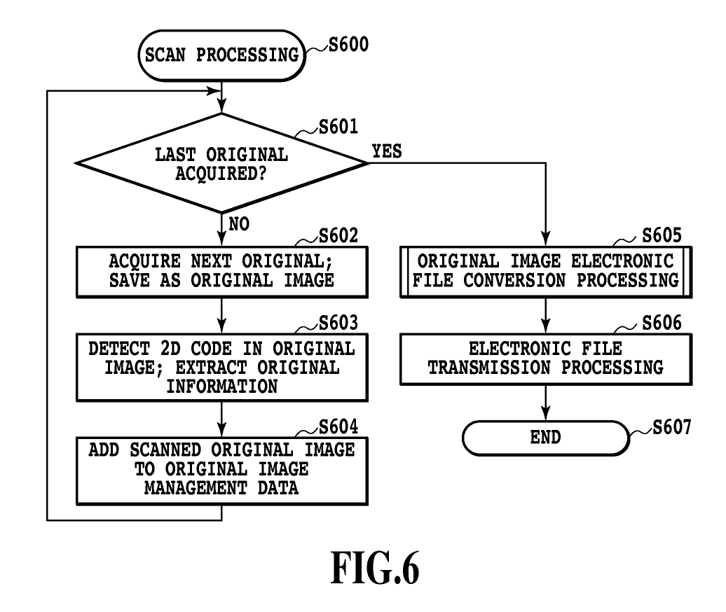

A mode wherein original images obtained by scanning are all collected into a single electronic file 501 will now be described using FIGS. 5 and 6.

FIG. 5 illustrates an example of combining and converting scanned original images into a single file. FIG. 6 is a flowchart of the scanning process in this case.

In the example shown in FIG. 5, the scanned originals 201 to 204 are output as a single electronic file 501. This mode resembles the scanning process in the conventional case wherein two-dimensional codes are not attached to the originals. If a scan-allow password hash value is contained in the original information of a document, then it is necessary for the MFP 131 to conduct a permission check using the password.

The process shown in FIG. 6 is initiated when a send mode displayed on the operation screen of the MFP 131 is selected and when input pressing a start button on the operation panel is received from the user. Herein, the processing in each step shown in FIG. 6 is under general control by a CPU in the MFP 131.

First, the process is initiated in step S600.

Next, in step S601, the MFP 131 checks the originals on the automatic document feeder (ADF) and determines whether or not all originals have been scanned. If all originals have been scanned, then the process proceeds to step S605. In contrast, if originals to be scanned still remain, then the process proceeds to step S602.

In step S602, the MFP 131 scans the original on the platen glass to generate an original image in the form of an electric signal, which is then saved as an original image in bitmap format in a storage device in the MFP 131.

In step S603, the MFP 131 detects the area where the two-dimensional code is present from the original image saved in step S602. In addition, the MFP 131 decodes the two-dimensional code in the detected area, and then stores the original information for the original in the memory of the MFP 131. In this way, in step S603, it is detected whether or not there is a two-dimensional code, and if so, original information is stored in memory. The process then proceeds to step S604.

Next, in step S604, the MFP 131 adds the original information extracted in step S603 to original image management data in memory. The process then proceeds to step S601.

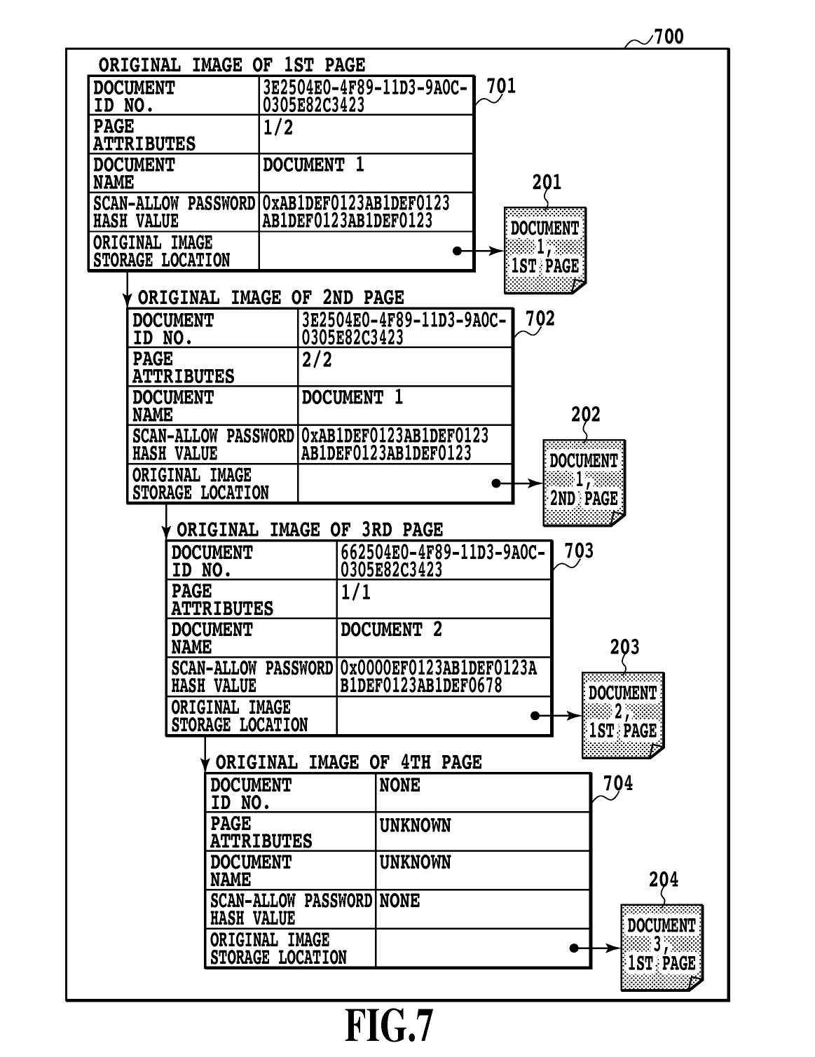

At this point, the above original image management data will be described using FIG. 7.

FIG. 7 is an example of original image management data 700 in the case of scanning an original group containing a plurality of documents as shown in FIG. 2.

The MFP 131 associates the original images of the originals 201 to 204 with respectively corresponding original information 701 to 704. In addition, the MFP 131 generates original image management data 700 that manages the original information 701 to 704 in a link structure. The original information for a newly-scanned original image is added to the end of the original image management data 700, and thus the original information 701 to 704 is managed in the same order as the originals at the time of scanning.

Herein, original images for which a two-dimensional code could not be detected or decoded in step S603 are recognized by the MFP 131 as being originals that do not include a two-dimensional code. In other words, in the original image management table, such originals are managed as documents for which original information cannot be specified, as shown in the original information 704. In other words, the attributes in the table become: document identification number: none, page attributes: unknown, document name: unknown, and scan-allow password hash value: none.

The description will now return to the scanning process shown in FIG. 6.

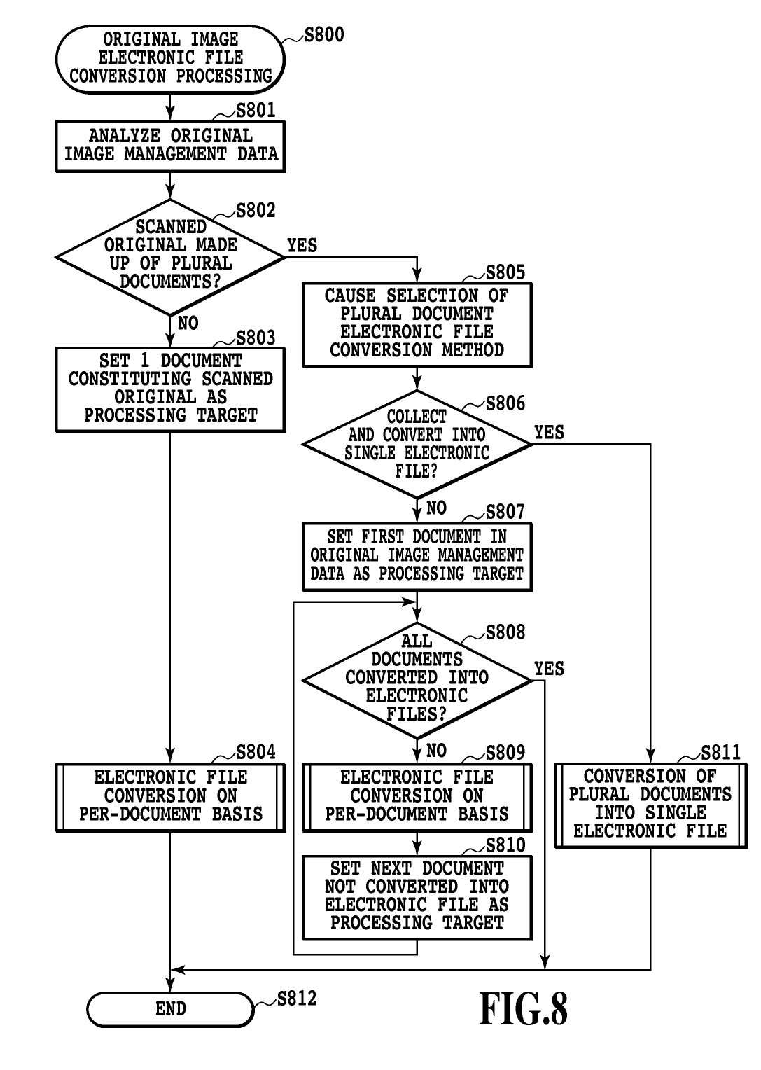

In step S605, the MFP 131 executes the electronic file conversion process for the original images obtained by scanning. The details of this process will be later described in detail using FIG. 8.

Subsequently, the process proceeds to step S605. In step S606, the MFP 131 sends the generated electronic file to the address configured in “Send mode”.

The process then proceeds to step S607 and terminates.

### (Electronic File Conversion Process)

Electronic file conversion processing of original images in step S605 will now be described using FIG. 8.

The processing in each step shown in FIG. 8 is under general control by the CPU in the MFP 131.

First, the process is initiated in step S800.

Subsequently, in step S801, the MFP 131 checks, on the basis of the original image management data 700 constructed in the previous step S604, whether or not the scanned original group is made up of a plurality of documents. More specifically, the MFP 131 checks the number of different document identification numbers in the original image management data 700. If the number of document identification numbers is 1, then the MFP 131 determines that the scanned original group is made up of a single document. If the number of different document identification numbers is 2 or more, then the MFP 131 determines that the scanned original group is made up of a plurality of documents. The process then proceeds to step S802.

In step S802 (original structure judgment), if the scanned original group is made up of a single document, then the MFP 131 advances the process to step S803. In contrast, if the scanned original group is made up of a plurality of documents, then the MFP 131 advances the process to step S805.

In step S803, the MFP 131 takes the processing target to be the original group made up of a single document, and then the process proceeds to step S804.

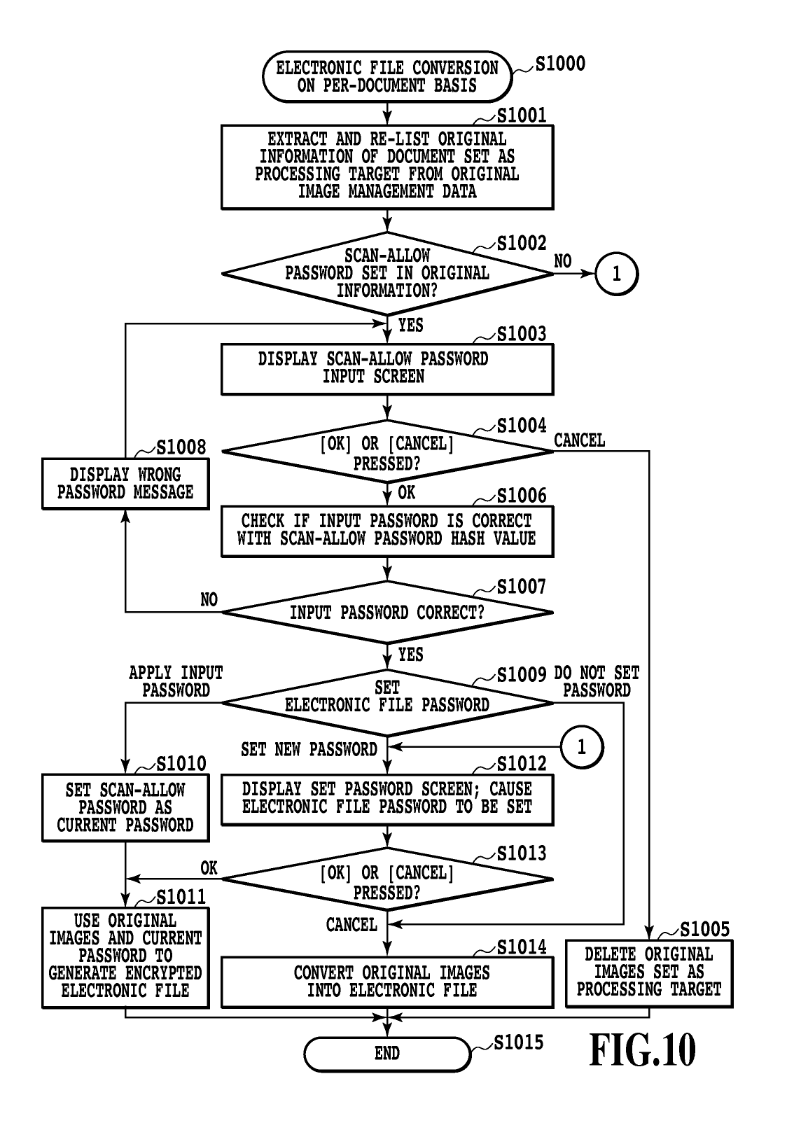

In step S804, the MFP 131 executes electronic file conversion on a per-document basis, advances the process to step S812, and then terminates the series of processes. Electronic file conversion on a per-document basis will be later described in detail using FIG. 10.

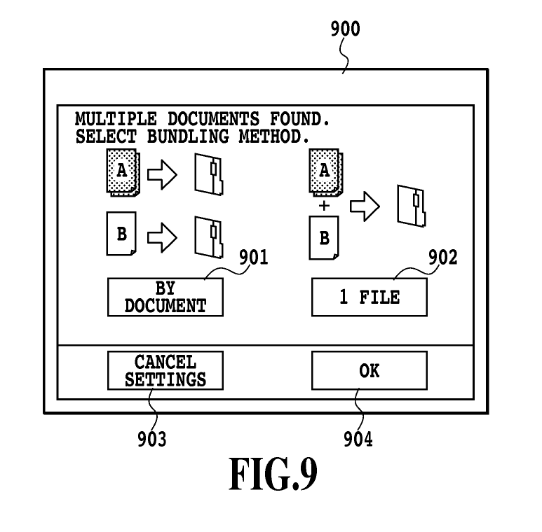

In contrast, in step S805, the MFP 131 causes the user to select an electronic file conversion method for the plurality of documents making up the original group. In the present embodiment, the operation screen 900 shown in FIG. 9 that causes the user to select an electronic file conversion method for a plurality of documents is displayed on the operation screen of the MFP 131, and then the MFP 131 waits for selection input by the user.

When the “By document” button 901 shown in FIG. 9 is pressed by the user, the MFP 131 recognizes that the user has selected the electronic file conversion on a per-document basis shown in FIG. 4. If the “1 file” button 902 shown in FIG. 9 is pressed by the user, then the MFP 131 recognizes that the user has selected the method wherein a plurality of pages of original images are all combined into a single electronic file 501, even if the original images have been obtained from a plurality of documents. Herein, the “By Document” button 901 and the “1 File” button 902 are exclusively selectable. Furthermore, the “By Document” button 901 is in a selected state by default.

If the “OK” button 904 is pressed by the user after a selection operation, then the settings for the currently selected “By document” button 901 or the “1 file” button 902 are retained, and the process proceeds to step S806. At this point, if a “Cancel settings” button 903 is pressed by the user, then the process proceeds to step S806 in the default settings state.

In the present embodiment, the operation screen 900 for selecting the electronic file conversion method for a plurality of documents shown in FIG. 9 is displayed at the time of step S805. However, the present embodiment may also be configured such that the operation screen 900 is displayed at the time of the send mode selection before the start button on the operation panel is pressed.

In the subsequent step S806 (structure decision), the MFP 131 checks the selection state of step S805, and decides the electronic file structure. More specifically, in the case of electronic file conversion on a per-document basis, the MFP 131 advances the process to step S807. In contrast, in the case of converting all scanned original images into a single electronic file, the MFP 131 advances the process to step S811.

In step S807, the MFP 131 sets the processing target to be the leading document in the original image management data 700 shown by way of example in FIG. 7, and then advances the process to step S808.

In step S808, if the MFP 131 is able to confirm that there still exist documents in the original image management data 700 that have not been converted into electronic files, then the MFP 131 advances the process to step S809. In contrast, if all documents in the original image management data 700 have been converted into electronic files, then the MFP 131 advances the process to step S812 and then terminates the process.

In step S809, the MFP 131 executes electronic file conversion on a per-document basis for the current processing target. Electronic file conversion on a per-document basis will be later described in detail using FIG. 10. The process then proceeds to step S810.

In step S810, the MFP 131 checks the original image management data 700, sets the processing target to the next document that has not been converted into an electronic file, and then advances the process to step S808.

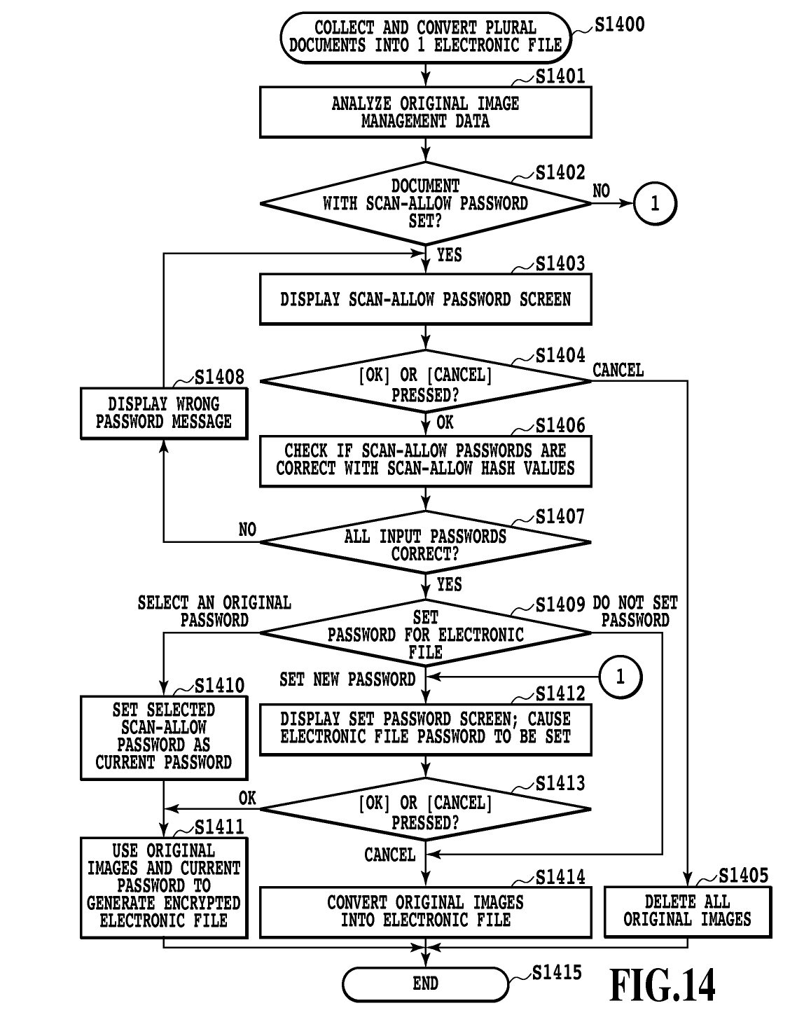

In contrast, in step S811, the MFP 131 executes electronic file conversion to convert the entire plurality of documents managed in the original image management data 700 into a single electronic file. The MFP 131 then advances the process to step S812 and then terminates the series of processes. The processing to convert a plurality of documents into a single electronic file will be later described in detail using FIG. 14.

### (Electronic File Conversion on a Per-Document Basis)

The electronic file conversion on a per-document basis conducted in the above step S804 and step S809 will now be described using FIG. 10.

FIG. 10 is a flowchart of electronic file conversion on a per-document basis. The processing in each step shown in FIG. 10 is under general control by the CPU in the MFP 131.

First, the process is initiated in step S1000.

Subsequently, in step S1001, the MFP 131 extracts and re-lists the original information related to the document set as the current processing target from the original image management data 700 constructed in step S604 described earlier, and then saves the resulting information in memory.

Next, in step S1002 (password detection), the MFP 131 advances the process to step S1003 in the case where a scan-allow password hash value is set in the original information of the document set as the processing target. In contrast, the MFP 131 advances the process to step S1012 in the case where a scan-allow password hash value is not set in the original information of the document set as the processing target.

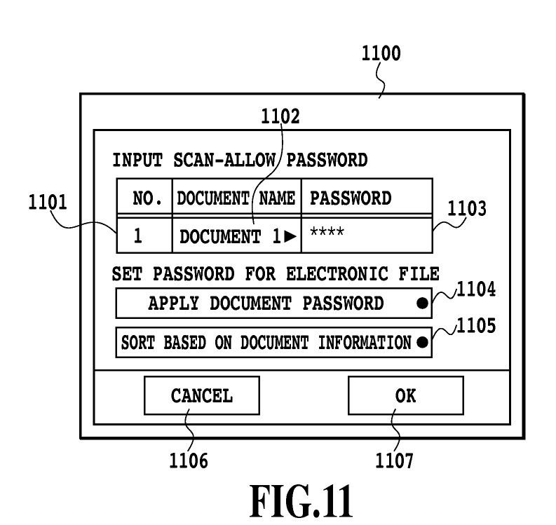

In step S1003, the MFP 131 displays a scan-allow password input screen on the operation screen, prompting the user to input a password into the scan-allow password input screen. In the present embodiment, the scan-allow password input operation screen 1100 shown in FIG. 11 is displayed on the operation screen of the MFP.

At this point, the scan-allow password input screen will be described using FIG. 11.

FIG. 11 is an example of an input screen for inputting a scan-allow password for a document 1.

As indicated by 1101, the scan-allow password input operation screen 1100 includes a “Document 1” button 1102 indicating that the document name of the document set as the current processing target is document 1, as well as a password input field 1103. By pressing the “Document 1” button 1102 on the operation screen, the password input field 1103 is selected, thereby enabling input of the password for document 1 using a numeric keypad on the operation panel. Furthermore, by touching the password input field 1103, a software keyboard appears on the operation screen, thereby enabling input of the password.

In addition, on the scan-allow password input operation screen 1100, there also exists a select button 1104 for selecting the password to be applied to the electronic file.

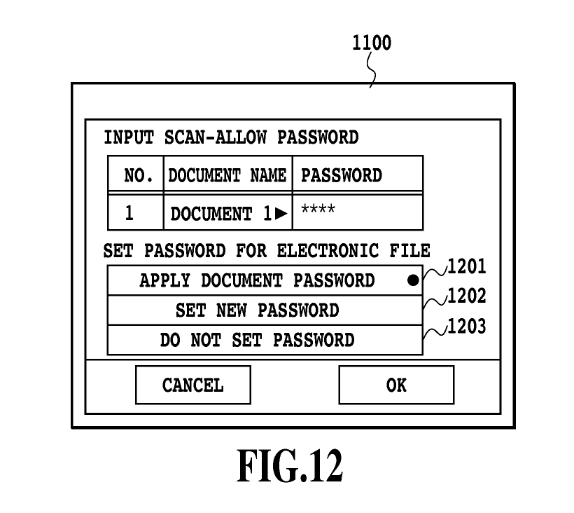

The select button will now be described with the additional use of FIG. 12.

FIG. 12 illustrates the state of the scan-allow password input operation screen 1100, in the case where the select button 1104 has been touched.

By touching the select button 1104, the options 1201 (Apply document password), 1202 (Set new password), and 1203 (Do not set password) are displayed, as shown in FIG. 12. By additionally touching one of the options, the touched option enters a selected state, with a circle being added to the right edge of the selected option. In addition, the display transitions to the display state shown in FIG. 11, and the content of the selected option is displayed over the select button 1104. The select button 1104 for selecting the password to be applied to an electronic file thus has the three exclusive options 1201, 1202, and 1203. Herein, the option 1201 is in a selected state by default.

The first option 1201 secures the electronic file by applying the scan-allow password related to the hash value that is included in the original information of the document set as the processing target. When this option is selected, the electronic file is encrypted using the same password as the password allowing scanning.

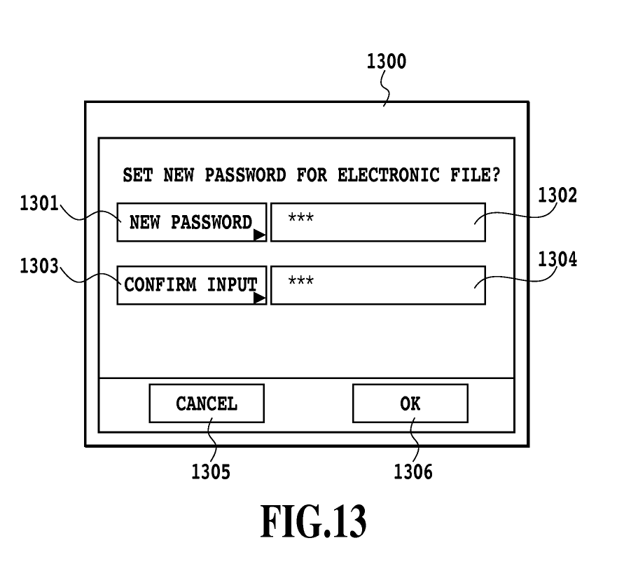

The second option 1202 sets a new password for the electronic file. The operation screen 1300 shown in FIG. 13 is displayed in step S1412, thereby prompting the user to input a new password. The details of this process will be later described using step S1412.

The third option 1203 does not set a password for the electronic file.

Furthermore, on the scan-allow password input operation screen 1100, there also exists a select button 1105 for selecting the order of the original images in the electronic file. The select button 1105 has two exclusive options: [Sort based on document information] and [Use original page order] (not shown in the drawings). By default, [Sort based on document information] is selected. By touching the select button 1105, the above two exclusive options are displayed. By additionally touching one of the options, the touched option enters a selected state, with a circle being added to the right edge of the selected option. In addition, the display transitions to the display state shown in FIG. 11, and the content of the selected option is displayed over the select button 1105.

Additionally, on the scan-allow password input operation screen 1100, there are an [OK] button 1107 and a [Cancel] button 1106. When the [OK] button 1107 or the [Cancel] button 1106 is pressed, the process transitions to step S1004 and proceeds as follows.

The above thus describes the scan-allow password input operation screen 1100.

At this point, the description will now return to FIG. 10.

In step S1004, if the [OK] button 1107 is pressed on the scan-allow password input operation screen 1100, then the MFP 131 advances the process to step S1006. In contrast, if the [Cancel] button 1106 is pressed on the scan-allow password input operation screen 1100, then the MFP 131 advances the process to step S1005.

In step S1005, since the [Cancel] button 1106 was pressed on the scan-allow password input operation screen 1100, the MFP 131 recognizes that the conversion of original images related to the documents set as the processing target into electronic files has been canceled. In the cancel processing, the MFP 131 checks the related original images from the list in the original information of the documents set as the processing target, and then deletes the related original images from the storage device in the MFP 131. In addition, the MFP 131 deletes the original information list of the documents set as the processing target from memory. After the above processing, the process advances to step S1015, and the series of processes is terminated.

In contrast, in step S1006, the MFP 131 uses the scan-allow password hash value in the original information of the document and checks if the password input into the password input field 1103 of the scan-allow password input operation screen 1100 is correct.

In the present embodiment, the processing to check if the password is correct is conducted as follows.

First, a one-way hash value is calculated from the password input into the password input field 1103 on the scan-allow password input operation screen. Subsequently, if the one-way hash value thus obtained is identical to the scan-allow password hash value in the original information of the document, then the input password is judged to be correct. In contrast, if the one-way hash value calculated from the password input into the password input field 1103 is not identical to the scan-allow password hash value in the original information of the document, then the input password is judged to be incorrect. In the present embodiment, password determination is thus conducted on the basis of hash values as in the above processing, but other schemes may also be implemented, wherein another common value acting as a key is introduced, for example.

In step S1007 (password verification), the MFP 131 inspects the password, and if the password input into the password input field 1103 is incorrect, then the MFP 131 advances the process to step S1008. In contrast, if the password input into the password input field 1103 is correct, then the MFP 131 advances the process to step S1009.

In step S1008, the MFP 131 displays a display on the operation screen indicating that the password is incorrect. Subsequently, the process proceeds to step S1003. The processing in step S1003 is the same as that described earlier.

In contrast, in step S1009, the MFP 131 checks the selected option of the select button 1104 for selecting the password to be applied to the electronic file on the scan-allow password input operation screen 1100 in FIG. 11.

If the first option 1201 is selected, then the MFP 131 advances the process to step S1010 in order to apply the password input into the password input field 1103 of the scan-allow password input operation screen 1100 to the electronic file.

If the second option 1202 is selected, then the MFP 131 advances the process to step S1012 in order to set a new password for the electronic file.

If the third option 1203 is selected, then a password is not set, and thus the MFP 131 advances the process to step S1014.

In step S1010, the MFP 131 takes the password that was input into the password input field 1103 of the scan-allow password input operation screen 1100 to be the current password. The process then proceeds to step S1011.

In step S1011, the MFP 131 follows the selected option of the above select button 1105 for selecting the order of the original images in the electronic file, and then rearranges the order of the original images. In addition, the MFP 131 generates an encrypted PDF using the original images in bitmap format related to the document set as the processing target, as well as the current password. In addition, the MFP 131 deletes from memory the list of the original information for the document set as the processing target, which has now been completely processed. After the above processing, the process proceeds to step S1015, and the series of processes is terminated.

In the present embodiment, PDF (Portable Document Format) is used as the format of the electronic file. When protecting an electronic file by means of a password (i.e., when encrypting an electronic file), an encrypted PDF is used. An encrypted PDF is one type of PDF file. In addition, where the above states that an encrypted PDF is generated using original images in bitmap format and a password, the following is meant. Original images in bitmap format are converted into PDF format to generate a PDF file. Then, in order to restrict viewing of the original images in PDF format, a password is applied to the PDF file. By applying a password, an encrypted PDF is generated. When a view command is issued from a user with respect to this encrypted PDF on a destination device, the original images in PDF format are displayed in the case where the applied password matches a password input by the user on the destination device. In contrast, if the passwords do not match, then the original images in PDF format are not displayed.

Herein, in the description of an embodiment in accordance with the present invention, the use of a PDF file is described as one example of an electronic file recording electronic data generated from original images read by the MFP 131. However, it should be appreciated that any type of electronic file can be applied to an embodiment in accordance with the present invention, so long as the electronic file can be encrypted.

In step S1012, the MFP 131 displays a screen for setting a new password on the operation screen, thus prompting the user to set a new password for the electronic file. FIG. 13 illustrates an example of a screen 1300 for setting a new password. The screen 1300 for setting a new password includes a [New password] button 1301 and a corresponding input field 1302. In addition, a [Confirm input] button 1303 and a corresponding input field 1304 are also included. By touching the [New password] button 1301 or the [Confirm input] button 1303, the respectively corresponding input field is selected, enabling input of a password with respect to the document 1 using a numeric keypad on the operation panel. In addition, by touching the input field 1302 or the input field 1304, a software keyboard appears on the operation screen, thereby enabling input of the password.

Additionally, the screen 1300 for setting a new password also includes a [Cancel] button 1305 and an [OK] button 1306. When the [OK] button 1306 is pressed, the MFP 131 checks if the password input into the input field 1302 and the input field 1304 are the same. If the passwords are different, the MFP 131 displays a message indicating that the password input is different. If the passwords are the same, then the MFP 131 takes that password to be the current password. By pressing the [Cancel] button 1305 or the [OK] button 1306, the MFP 131 advances the process to step S1013.

In step S1013, the MFP 131 judges whether the [OK] button 1306 or the [Cancel] button 1305 was pressed. If it is judged that the [OK] button 1306 was pressed, then the MFP 131 advances the process to step S1011 described earlier. In contrast, if the [Cancel] button 1305 was pressed, then the MFP 131 advances the process to step S1014.

In step S1014, the MFP 131 follows the selected option of the select button 1105 for selecting the order of the original images in the electronic file, and then rearranges the order of the original images. In addition, the MFP 131 generates a PDF using the original images in bitmap format related to the document set as the processing target. Lastly, the MFP 131 deletes from memory the list of the original information for the document set as the processing target, which has now been completely processed. After the above processing, the process proceeds to step S1015, and the series of processes are terminated.

(Converting a Plurality of Documents into a Single Electronic File)

The process for converting a plurality of documents into a single electronic file in step S811 will now be described in detail using FIG. 14.

The processing in each step shown in FIG. 14 is under general control by the CPU in the MFP 131.

First, the process is initiated in step S1400.

Subsequently, in step S1401, the MFP 131 takes the original image management data 700 constructed in the earlier step S604, and on the basis thereof, checks if there exists a document with a scan-allow password hash value set as original information.

Next, in step S1402 (password detection), if there does exist a document with a scan-allow password hash value set, then the MFP 131 advances the process to step S1403. In contrast, if a scan-allow password hash value is not set in the original information of any document included in the scanned original group, then the MFP 131 advances the process to step S1412.

In step S1403, the MFP 131 displays a scan-allow password input screen on the operation screen, thereby prompting the user to input a scan-allow password. In the present embodiment, the MFP 131 displays the scan-allow password input operation screen 1500 on the operation screen of the MFP 131.

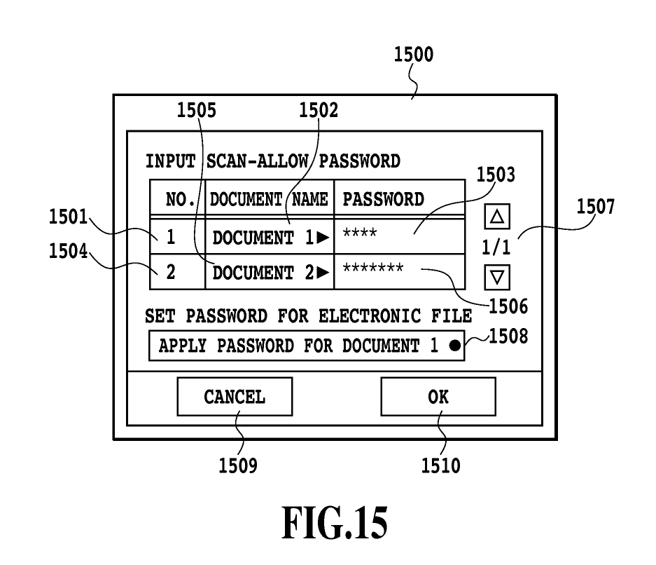

The scan-allow password input operation screen 1500 will now be described using FIG. 15.

The scan-allow password input operation screen 1500 includes a password input field with respect to only the documents having a scan-allow password hash value. In addition, the scan-allow password input operation screen 1500 also includes a password input field scroll button 1507 for the case wherein many documents have a scan-allow password hash value. FIG. 15 is an example of the scan-allow password input screen in the case of the original group 200 shown in FIG. 2. The original group 200 includes a document 1 and a document 2 recognizable by original information in the form of a two-dimensional code. In addition, the document 1 and the document 2 respectively include scan-allow password hash values. For this reason, the scan-allow password input operation screen 1500 includes the password input fields 1503 and 1506.

In the present embodiment, the scan-allow password input operation screen 1500 includes a [Document 1] button 1502 and a [Document 2] button 1505 showing the document names in order to distinguish the document for which a password has been input. In addition, in order to select the password to apply to the electronic file with a select button 1508 described later, the scan-allow password input operation screen 1500 also includes document numbers 1501 and 1504 respectively corresponding to the document 1 and the document 2.

By pressing the [Document 1] button 1502, the password input field 1503 is selected, thereby enabling input of the password corresponding to the document 1 by using the numeric keypad on the operation panel. By additionally touching the password input field 1503, a software keyboard appears on the operation screen, also enabling input of the password corresponding to the document 1. Similarly, by pressing the [Document 2] button 1505, the password input field 1506 is selected, thereby enabling input of the password corresponding to the document 2 by using the numeric keypad on the operation panel. By additionally touching the password input field 1506, a software keyboard appears on the operation screen, also enabling input of the password corresponding to the document 2. In this way, when there exists a plurality of documents having scan-allow password hash values, input of two or more passwords occurs.

Additionally, the scan-allow password input operation screen 1500 includes a select button 1508 (password deciding means) requesting the user to select the password to apply to the electronic file. In addition to [Set new password] and [Do not set password] options, the select button 1508 also includes options for only the documents having a scan-allow password hash value. These respective options use the values of the document numbers 1501 and 1504, and are expressed in the format [Apply No. (document number) password]. By default, the [Apply password for document 1] is selected. In this case, the password associated with the document number is set. Since FIG. 15 shows an example in the case of the original group 200, the select button 1508 includes the following four exclusive options: [Apply password for document 1], [Apply password for document 2], [Set new password], and [Do not set password].

Additionally, the scan-allow password input operation screen 1500 also includes an [OK] button 1510 and a [Cancel] button 1509. When the [OK] button 1510 or the [Cancel] button 1509 is pressed, the process proceeds to step S1404.

In step S1404, if the [OK] button 1510 was pressed on the scan-allow password input operation screen 1500, then the MFP 131 advances the process to step S1406. In contrast, if the [Cancel] button 1509 was pressed on the scan-allow password input operation screen 1500, then the MFP 131 advances the process to step S1405.

In step S1405, the [Cancel] button 1509 was pressed on the scan-allow password input operation screen 1500, and thus the MFP 131 recognizes that the processing to convert a plurality of documents into a single electronic file has been canceled. Consequently, the MFP 131 checks the related original images on the basis of the original image management data 700, and then deletes all original images from the storage device of the MFP 131. In addition, the MFP 131 also deletes the original image management data 700 from memory. After the above processing, the process proceeds to step S1415, and the series of processes is terminated.

In contrast, in step S1406, the MFP 131 takes all passwords input into the password input fields 1503 and 1506, and then uses the scan-allow password hash values in the original information of corresponding documents to check if the input passwords are correct.

Next, in step S1407 (password verification), the MFP 131 inspects the passwords, and if any one of the passwords input into the password input fields 1503 and 1506 is incorrect, then the MFP 131 advances the process to step S1408. In contrast, if all of the passwords input into the password input fields 1503 and 1506 are correct, then the MFP 131 advances the process to step S1409.

In step S1408, the MFP 131 displays a display on the operation screen indicating that the input passwords are incorrect. The process then proceeds to the earlier step S1403.

In contrast, in step S1409, the MFP 131 checks the selected option of the select button 1508 for selecting the password to apply to the electronic file on the scan-allow password input operation screen 1500.

At this point, if [Apply No. (document number) password] is selected, then the MFP 131 advances the process to step S1410 in order to provide the password input into the password input field of the corresponding document number to the electronic file.

If [Set new password] is selected, then the MFP 131 advances the process to step S1412 in order to set a single new password for the electronic file as a substitute for the entire plurality of passwords.

If [Do not set password] is selected, then the MFP 131 does not set a password, and thus advances the process to step S1414.

In step S1410, the MFP 131 takes the current password to be the password input into the password input field corresponding to the document number of the [Apply No. (document number) password] option. For example, if the [Apply password for document 1] option is selected, then the current password is taken to be the password input into the password input field 1503.

Next, in step S1411, the MFP 131 generates an encrypted PDF using the original images in bitmap format related to the documents set as the processing target, as well as the current password. In addition, the MFP 131 deletes the original image management data 700 from memory. After the above processing, the process proceeds to step S1415, and the series of processes is terminated.

In contrast, in step S1412, the MFP 131 displays the screen 1300 for setting a new password shown in FIG. 13 on the operation screen, thereby prompting the user to set a new password for the electronic file. The operation of the screen 1300 for setting a new password is the same as that described earlier.

Subsequently, by pressing the [OK] button 1306 or the [Cancel] button 1305, the MFP 131 advances the process to step S1413.

In step S1413, the MFP 131 judges whether the [OK] button 1306 or the [Cancel] button 1305 was pressed. If the [OK] button 1306 was pressed, then the MFP 131 advances the process to step S1411. In contrast, if the [Cancel] button 1305 was pressed, then the MFP 131 advances the process to step S1414.

In step S1414, the MFP 131 generates an electronic file in PDF format using the original images in bitmap format related to the documents set as the processing target. Lastly, the MFP 131 deletes the original image management data 700 from memory. After the above processing, the process advances to step S1415, and the series of processes is terminated.

The foregoing thus describes in detail an embodiment 1 of the present invention.

In the foregoing embodiment 1, the MFP 131 displays the scan-allow password input operation screen 1500 shown in FIG. 15 on the operation screen. Subsequently, a password is input in a password input field for each corresponding document using input means such as a numeric keypad or a software keyboard. In the Embodiments 2 and 3 of the present invention hereinafter described, the following refinements are introduced in order to reduce the number of times the same password is input in Embodiment 1.

### Embodiment 2

Hereinafter, only the portions that differ from Embodiment 1 will be described.

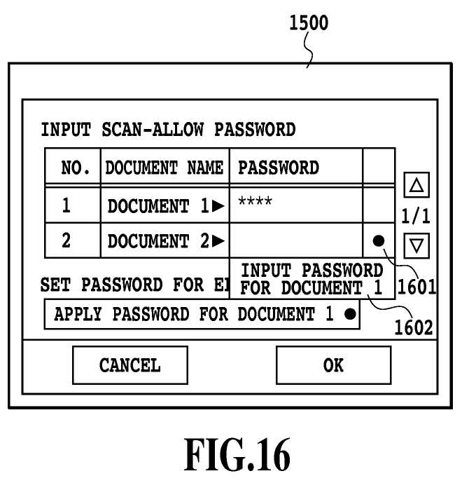

In the present embodiment, the select button 1601 shown in FIG. 16 is added to the side of the password input fields for the second and subsequent document numbers on the scan-allow password input operation screen 1500 displayed in step S1403 of the foregoing Embodiment 1.

If the select button 1601 is selected, then the MFP 131 displays options in the format [Input password for document (document number)], thereby prompting the user to select an option. The MFP 131 then sets the password for the document number of the selected option in the password input field 1506 (FIG. 15) corresponding to the select button 1601. In so doing, an already-input password can be selected and automatically input, thereby reducing the number of times the same password is input.

The foregoing thus describes the Embodiment 2 of the present invention.

### Embodiment 3

Hereinafter, only portions that differ from Embodiment 1 will be described.

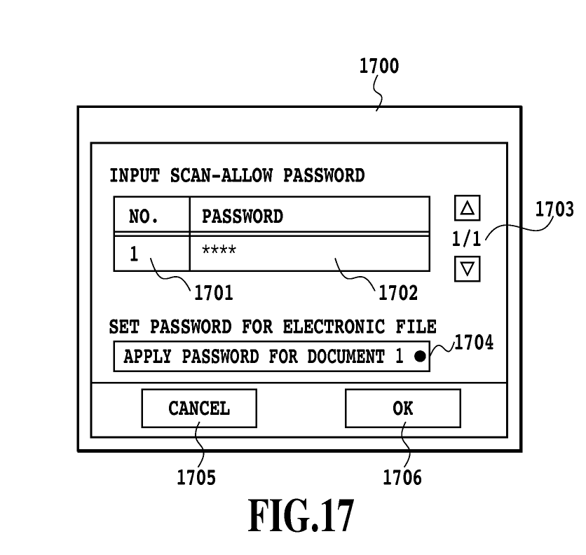

In the present embodiment, the scan-allow password input operation screen 1700 shown in FIG. 17 is displayed in step S1403 of the foregoing Embodiment 1. On the scan-allow password input operation screen 1700, password input fields are not shown for each document name. Instead, an input field 1702 is displayed only for different scan-allow password hash values included in the original information of the original group. As a result, the number of times a password is input for different documents having the same scan-allow password hash value can be reduced. However, in the present embodiment, in step S1406, it is necessary for the MFP 131 to check whether all scan-allow password hash values in the original information included in the original group are correct with respect to the individual input passwords.

The foregoing thus describes the Embodiment 3 of the present invention.

### Embodiment 4

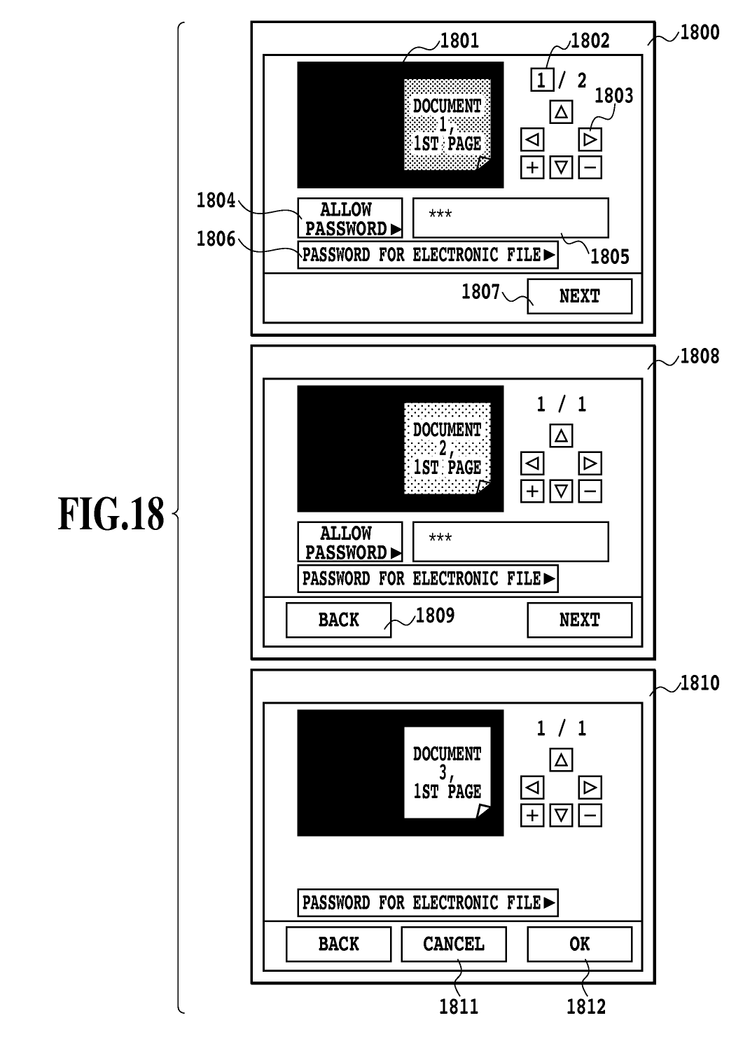

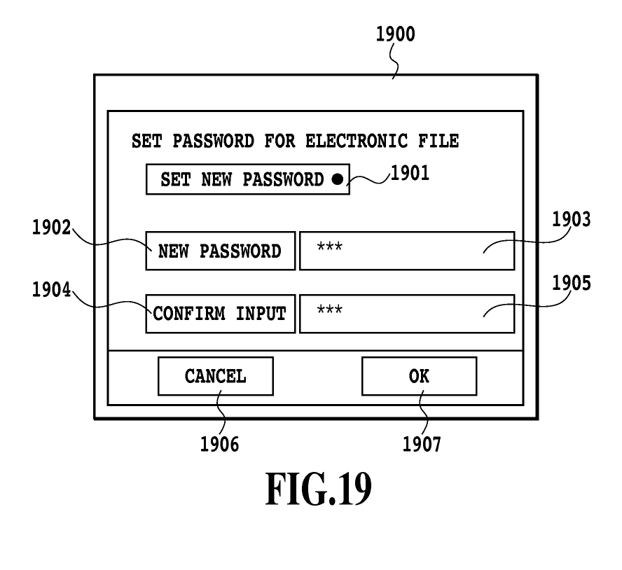

The present embodiment is for conducting scan-allow password input in a wizard format and in conjunction with a document preview. The present embodiment will be described using FIGS. 18 and 19. Hereinafter, only portions that differ from Embodiment 1 will be described.

FIG. 18 illustrates scan-allow password input operation screens together with per-document previews. FIG. 18 is a display example for the case of the original group 200. The document previews 1800, 1808, and 1810 are respective preview screens for the document 1, document 2, and document 3 included in the original group 200. A document preview includes a document original image display portion 1801, an input field 1802 for specifying the displayed page, and buttons 1803 for enlarging/shrinking the original image preview display and moving the display range. In addition, in the case where there exists a scan-allow password hash value in the original information of a document, the document preview also includes a password input button 1404 and a corresponding input field 1805. In the case of the original group 200, the document 1 and the document 2 are protected by scan-allow passwords, and thus the password input button 1804 and the corresponding input field 1805 exist on the document previews 1800 and 1808.

Furthermore, the document preview also includes a button 1806 for selecting the password to apply to the electronic file. By pressing the button 1806, the operation screen 1900 for setting a password for an electronic file shown in FIG. 19 is displayed on the operation screen of the MFP 131. On the operation screen 1900 for setting a password for an electronic file, there exists a select button 1901 (password determining means). The select button 1901 includes the same options as the select button 1508 in Embodiment 1, and also operates in the same way.

When the [Set new password] option is selected, input can be received in the password input fields 1903 and 1905 by pressing the buttons 1902 and 1904 for setting a new password. The buttons 1902 and 1904 correspond to the buttons 1301 and 1303 shown in FIG. 13 in Embodiment 1, while the input fields 1903 and 1905 correspond to the input fields 1302 and 1304, and the above operate in the same way.

In addition, there also exists a [Cancel] button 1906 and an [OK] button 1907 on the operation screen 1900 for setting a password for an electronic file. When the [OK] button 1907 is pressed, the MFP 131 returns to the document preview screen where the button 1806 was pressed. However, if the [Set new password] option of the select button 1901 was selected, then the MFP 131 returns to the document preview screen where the button 1806 was pressed only in the case where the same password has been input into the input fields 1903 and 1905. If the [Cancel] button 1906 is pressed, then the MFP 131 returns to the document preview screen where the button 1806 was pressed, leaving the select button 1901 at the default value.

Since the document previews 1800, 1806, and 1810 are controlled in wizard format, a [Next] button 1807 and a [Back] button 1809 for moving among documents are included. The preview screen 1810 for the final document also includes a [Cancel] button 1811 and an [OK] button 1812. When the [Cancel] button 1811 or the [OK] button 1812 is pressed, the MFP 131 advances the process to step S1404 described earlier.

The foregoing thus describes Embodiment 4 of the present invention.

### Other Embodiments

The foregoing embodiments are herein assumed to use two-dimensional codes, but one-dimensional codes, electronic watermarks, or steganography may also be used.

In addition, although the foregoing embodiments are described as using memory as a medium for storing data, such memory can be substituted with any medium able to store data (such as an HDD or RAM, for example).

In addition, the foregoing embodiments are described assuming that the MFP scans the original group. Typically, scanning refers to optically acquiring images of the originals. For example, the object of the present invention can also be achieved by means of photography using a digital camera.

In addition, the foregoing embodiments are described with respect to a single MFP capable of image acquisition, information processing, as well as image printing onto sheets of paper. However, the devices that individually conduct image acquisition, information processing, and printing onto sheets of power may also be separate devices.

In the present specification, a device capable of at least processing information is referred to as an image processing apparatus. In addition, a device capable of at least processing information and printing images onto sheets of paper is referred to as an image forming apparatus.

In the foregoing embodiments, the case of an MFP with an ADF installed is described. However, even if an ADF is not installed, it is possible for an MFP to judge that all originals have been scanned by providing a button on the operation screen for the user to notify the MFP that all originals have been scanned.

In addition, the object of the present invention is also achieved as a result of a computer reading and executing program code from a computer-readable storage medium storing program code that realizes the sequences of the flowcharts illustrated in the foregoing embodiment. In this case, the program code itself that is read from the storage medium realizes the functions of the embodiment. For this reason, such program code and the storage medium storing such program code may also constitute embodiments of the present invention.

The storage medium for supplying the program code may include, for example, a floppy™ disk, a hard disk, an optical disc, a magneto-optical disk, a CD-ROM, a CD-R, magnetic tape, a non-volatile memory card, or ROM.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-132332 filed May 20, 2008 which is hereby incorporated by reference herein in its entirety.

1. An image processing apparatus, comprising:
password detecting means for judging whether original information obtained by decoding a two-dimensional code in an original image contains a one-way hash value generated from a password;
password inputting means for prompting input of a password in the case where it is determined by said password detecting means that a hash value is contained in the original information;
password verifying means for using the one-way hash value to verify a password input by said password inputting means; and
convening means for convening the original image into an electronic file protected by the password input by said password inputting means.

2. The image processing apparatus according to claim 1, further comprising:
original structure judging means for judging, from original information obtained by decoding two-dimensional codes in original images obtained from a scanned original group, whether the original group is made up of a plurality of documents; and
structure determining means for determining whether to convert the original images into separate electronic files for each original image or into a single electronic file, in the case where it is judged by said original structure judging means that the original group is made up of a plurality of documents; wherein
said convening means conducts electronic file conversion on the basis of the determination made by said structure determining means.

3. The image processing apparatus according to claim 2, further comprising:
password determining means for determining the password to be applied to an original image when convening the original image into a password-protected electronic file by said convening means, in the case where (i) it is determined by said structure determining means to convert a plurality of documents into a single electronic file, and (ii) the input of two or more passwords is produced by said password inputting means.

4. The image processing apparatus according to claim 3, wherein in said password inputting means, passwords are caused to be input in association with document identification numbers included in the original information of the originals.

5. The image processing apparatus according to claim 3, wherein
in said password inputting means, a number of passwords equal to the number of different one-way hash values included in the original information of a plurality of documents is caused to be input.

6. The image processing apparatus according to claim 3, wherein in said password inputting means, passwords are caused to be input in association with a document preview for each document.

7. The image processing apparatus according to claim 3, wherein in said password inputting means, when the input of a plurality of passwords is produced in said password inputting means, a user is requested to either select a single password from among the plurality of input passwords, or alternatively, to input a single password completely different from the plurality of input passwords that will become a substitute for the entire plurality of input passwords.

8. An image processing method executed by an image processing apparatus, comprising the steps of:
detecting a password by determining whether original information obtained by decoding a two-dimensional code in an original image contains a one-way hash value generated from a password;
inputting a password by prompting input of a password in the case where it is determined in said password detecting step that a hash value is contained in the original information;
verifying a password by using the one-way hash value to verify the password input in said password inputting step; and
convening the original image into an electronic file protected by the password input in said password inputting step.

9. A program on a computer-readable medium causing an image processing apparatus to execute an image processing method, the image processing method comprising the steps of:
detecting a password by determining whether original information obtained by decoding a two-dimensional code in an original image contains a one-way hash value generated from a password;
inputting a password by prompting input of a password in the case where it is determined in the password detecting step that a hash value is contained in the original information;
verifying a password by using the one-way hash value to verify the password input in the password inputting step; and
convening the original image into an electronic file protected by the password input in the password inputting step.
